(19) United States
(12) Patent Application Publication
(10) Pub. No.: US 2018/0046817 A1
(43) Pub. Date: Feb. 15, 2018

(54) DOCUMENT VERIFICATION SYSTEM

(71) Applicant: Atul GUPTA, Chandigarh (IN)

(72) Inventor: Atul GUPTA, Chandigarh (IN)

(21) Appl. No.: 15/543,422

(22) PCT Filed: Jan. 14, 2016
(86) PCT No.: PCT/IB2016/050162

§ 371 Date: Jul. 13, 2017

(30) Foreign Application Priority Data
Jan. 16, 2015 (IN) 139/DEL/2015

(51) Int. Cl. G06F 21/62; G06F 21/30; H04L 9/32; G06F 17/30

(52) U.S. Cl. CPC G06F 21/6209; G06F 17/30887; G06F 21/305; H04L 9/3263

(57) ABSTRACT

The present invention provides a method and system to facilitate the verification of genuineness of a document by visiting a unique, non-forgeable, permanent URL printed on the document and comparing the document against the original document stored at a database hosted by the system of the present invention. The verifier is given a verification certificate which can also be checked for genuineness by visiting another unique URL printed on the verification certificate.

### BACKGROUND OF THE INVENTION

### Field of the Invention

The invention relates in general to verification of documents such as mark sheets, certificates, ID cards, invoices, etc. without requiring any skilled technician or costly job-specific hardware.

### Related Art

Documents such as mark sheets, certificates, ID cards, invoices, bank certificates, credentials, license, and the like have become an imperative part of everyday life. It is often considered to check the genuineness/authenticity of such documents as forged documents may cause a considerable loss to organizations. In 2009, Powerchex claimed that nearly one in 5 applicants have a major lie or discrepancy on their application. CBC News of Canada reported that fraud in the workplace cost Canadian Businesses over $3.2 Billion in 2011.

Verification of genuineness of documents is needed to establish trust with a stranger when hiring for skilled employee, during college admissions, while contracting with person on behalf of a company, for marriage proposal claiming well educated or employed.

But, the task of verifying the genuineness of a document is either a time consuming process or requires a regular contract (in form of an online account) with different issuing organizations. For verification, a verifier needs contact information of the document issuer to contact and ask for the genuineness of the document. The document issuer in turn has to keep records of all the documents ever issued, so as a verifier can cross verify the details. These time consuming verification processes is many times not acceptable and lead to losses to both, the document holder as well the verifier.

Further, a variety of methods and systems for checking fraudulent documents with the help of computers and machines are also present in the prior art. The disadvantage of these prior art systems is that they require costly hardware to verify the genuineness of a document. One of the safest known methods to prevent a document from being faked is to store information indicating genuineness of the document thereon in the form of diffraction gratings, steganographs or holograms. Such diffraction gratings, steganographs or holograms can be read and checked for their genuineness easily by a machine. However, these methods require the use of costly technical machines and expert knowledge.

Some documents contain holograms embossed in a plastic support member on them as a proof of genuineness. Furthermore, an identity card is known which is formed by stamping a refracting pattern into a plastic support member. However, it has not proved possible to use the hologram or diffraction grating methods for verifying the genuineness of documents without the use of costly technical machines and expert knowledge.

Furthermore, a verifier or a verifying authority doesn't have the record of the proof that a document has been verified. Thus a verifier cannot be cross checked whether he/she has verified a document or not.

All such methods and systems known in the prior art fail to enable the person to verify fake documents easily and instantly.

It is therefore desirable to have systems and processes to facilitate verification of genuineness of documents with ease and which do not require any job-specific costly hardware.

### SUMMARY OF THE INVENTION

The present invention provides a method and system to facilitate the verification of genuineness of documents. The system of the present invention does not require any skilled technician or costly job-specific hardware such as scanners, sensors, cameras, barcode readers, or the likes.

The present invention provides a method and system where an authorized institution issues a document with a unique, non-forgeable, permanent URL printed on it. A copy of the document is then stored at a database hosted by the system of the present invention. The system of the present invention also facilitates a verifying authority for instant verification of genuineness of the document simply by visiting the URL printed on the document with the help of any internet enabled device.

The present invention provides a method and system where a verifier or a verifying authority can instantly verify the genuineness of a document simply by visiting a URL printed on the document with the help of any internet enabled device. The verifier is then given a verification certificate which can be used as a proof of verification by the verifier.

The present invention provides a method and system which enable a verifier to confirm genuineness of a document as well as of the issuing authority, who issued the document, by visiting a unique, non-forgeable, permanent URL printed on the document and comparing the submitted copy of the document against the original document stored at a database hosted by the system of the present invention. The verifier is then given a verification certificate which can be used as a proof of verification by the verifier. The verification certificate can also be checked for genuineness by a cross verifier by visiting another unique URL printed on the verification certificate.

The present invention provides a method and system to facilitate the updation of a document issued by an issuing authority. The document can be corrected/updated on the system of the present invention and a verifier of the document is notified, if the document had been previously verified, about the correction/updation of the document.

The present invention provides a method and system for document verification. The system of the present invention does not require any special scanning/printing devices (neither by issuer, nor by verifier), public-private hash generation, security seals, advanced printing-viewing techniques, holograms or trusted courier/communication network; hence freeing both verifier and issuer from having advanced technical setup or know-how.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 illustrates verification system in brief by which genuineness of a document is verified facilitating faster establishment of trust among transacting parties, in accordance with an embodiment of the invention.

FIG. 2 further illustrates the verification system in detail by which genuineness of a document is verified, in accordance with an embodiment of the invention.

FIG. 3 illustrates process by which a new institute is registered and authorized on the system, creating trust level 1, which facilitates verification of issuer of the document, in accordance with an embodiment of the invention.

FIG. 4 illustrates process by which the authorized institutes create and approve data officers, creating trust level 2, for creating and publishing documents on the system, in accordance with an embodiment of the invention.

FIG. 5 illustrates process by which a new document is created, approved and published with verification URL on the system by the authorized officer, creating trust level 3, facilitating printing and verification of genuineness of the document, in accordance with an embodiment of the invention.

FIG. 5-A demonstrates a sample document with verification URL printed on it as generated by the system facilitating 1-click verification by a viewer, in accordance with an embodiment of the invention.

FIG. 6 illustrates process by which a document is verified by a verifier, creating trust level 4, and a certificate of verification is generated by the system, creating trust level 5, for future references, in accordance with an embodiment of the invention.

FIG. 7 illustrates process by which any change in a document is notified to all the verifiers of the document facilitating removal of any errors or probable flaws, creating trust level 6, in accordance with an embodiment of the invention.

### DETAILED DESCRIPTION

From the foregoing detailed description of certain embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention.

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

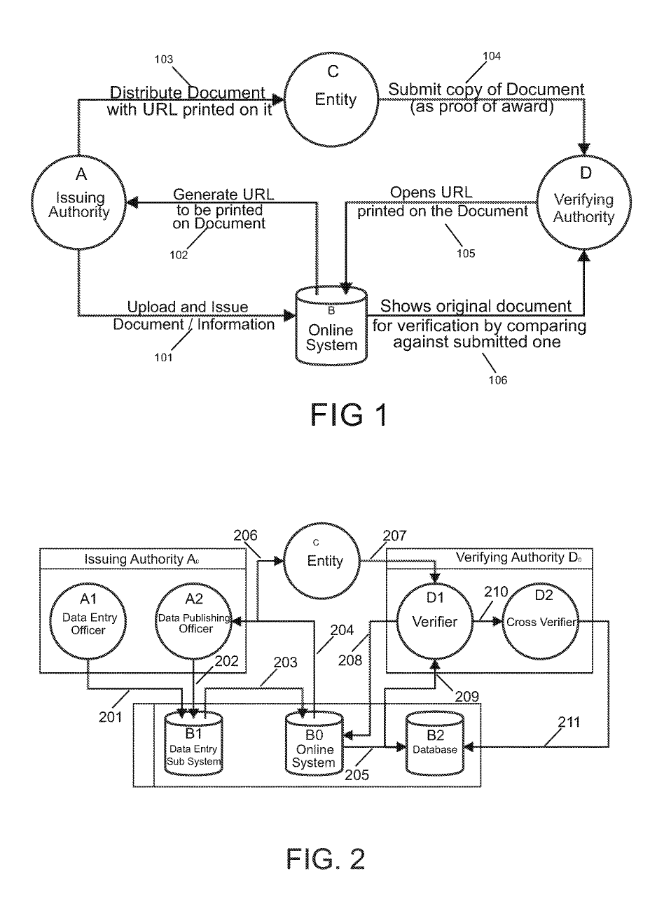

FIG. 1 shows a flow diagram illustrating the implementation of a system for verification of genuineness of a document according to an exemplary embodiment of the present invention. The system comprises a document issuing authority A, an online system B, and a verifying authority D.

The issuing authority A is an organization that issues documents such as but not limited to mark sheets, certificates, ID cards, invoices, credentials, license, and the like. The issuing authority A can be an institution, university, bank, financial body, companies, government organizations, or the like. The verifying authority D is a part of an organization (not shown) who wants to verify the genuineness of a document presented by an entity C wherein the entity C is a document holder who had been issued the document by the issuing authority A. The invention has been described herein using only one issuing authority A and verifying authority D, however any number of issuing authorities A and verifying authorities D can register with online system B according to different embodiments without departing from the scope of the present invention.

In one exemplary implementation, the method includes steps that can be implemented in parts at the issuing authority A, the online system B, and the verifying authority D.

The issuing authority A has a registered account with the online system B. When the issuing authority A has to issue a document, it uploads the document and all information related to the document and to whom it is to be issued on the online system B at step 101. At step 102, the online system B generates a unique URL for the document and provides the unique URL to the issuing authority A. The online system B also stores an original copy of the document along with the generated URL in a database (not shown) hosted by the online system B. The functionalities of the online system B are implemented using one or more processing elements, which are not herein explained in detail as they are very well known to an ordinary skilled in the related art.

At step 103, the issuing authority A issues a printed copy of the document to the entity C (document holder) with the URL printed on it. At step 104, the entity C submits copy of the document to an organization (not shown). The organization has a verifying authority D to verify the genuineness of the document submitted by the entity C. At step 105, the verifying authority D visits the URL printed on the document using any internet enabled device such as but not limited to laptop, PC, PDA, smart phone, tablet, or any other such device known to an ordinary skilled in the art. At step 106, the URL links the verifying authority with the online system B and displays the original copy of the document stored at the database hosted by the online system B via a user interface on a device operated by the verifying authority. The verifying authority D can compare the submitted copy of the document with the original copy and ascertain the genuineness of the document.

In an exemplary embodiment of the present invention, authenticity of a document that is appended (printed) with a unique URL, as disclosed in the present invention, can be verified by any end user, wherein the end user may be any of entity, person, organization, software, and like. The end user may scan and parse the appended URL via suitable means (e.g., by using a mobile application, or by running the URL on a web-browser) for getting access to an authentic copy stored in a remote database. Thereafter, the end user may compare the accessed copy with the document under verification to determine authenticity of the document. The end user may also use softwares to automate the process of scanning and parsing the URL and then accessing and comparing the accessed file to determine authenticity of the document under verification. Similarly, the end user may also be facilitated to access and parse copy of the verification certificate stored in the remote database.

FIG. 2 shows a flow diagram illustrating the implementation of a system for verification of genuineness of a document according to another exemplary embodiment of the present invention. The system of FIG. 2 comprises a document issuing authority A0, an online system B0, and a verifying authority D0.

The issuing authority A0 has a data entry officer A1 who, at step 201, uploads a document and enters information related to the document and to whom the document is to be issued in a Data Entry subsystem B1 of the online system B0. The issuing authority A0 has a data publishing officer A2 who, at step 202, approves the information entered by the data entry officer A1. At step 203, Data Entry subsystem B1 uploads the information on the online system B0. The issuing authority A0 can be connected to online system B0 using any internet enabled device such as but not limited to laptop, PC, PDA, smart phone, tablet, or any other such device known to an ordinary skilled in the art. At step 204, the online system B0 generates a unique URL for the document and provides the document with the unique URL written on it to the data publishing officer A2 of the issuing authority A0. At step 205, the online system B0 stores an original copy of the document in a database B2 hosted by the online system B0. The functionalities of the online system B0 are implemented using one or more processing elements, which are not herein explained in detail as they are very well known to an ordinary skilled in the related art.

At step 206, the data publishing officer A2 of the issuing authority A0 issues a printed copy of the document to the entity C (documents holder) with the unique URL printed on it. At step 207, the entity C submits copy of the document to an organization (not shown). The organization has a verifying authority D0 to verify the genuineness of the document submitted by the entity C. The verifying authority D0 comprises a verifier D1 and a cross verifier D2.

At step 208, the verifier D1 visits the unique URL printed on the document using any internet enabled device such as but not limited to laptop, PC, PDA, smart phone, tablet, or any other such device known to an ordinary skilled in the art. At step 209, the URL links the verifier D1 with the online system B0 and displays the original copy of the document stored at the database B2 hosted by the online system B0. The verifier D1 can compare the submitted copy of the document with the original copy and if the submitted document matches the original copy, the verifier D1 ascertains the genuineness of the document by selecting an option “Match” on an interface provided by the online system B0. But if the submitted document does not match with the original copy, the verifier D1 selects another option “Does Not Match” on the interface provided by the online system B0. According to an exemplary embodiment of the present invention, if the submitted document does not match with the original copy, the submitted faulty document can be uploaded on the online system B0 for further reference of the issuing authority A0, entity C, or the verifying authority D0.

Once the verifier D1 ascertains the genuineness of the document, the online system B0 generates a verification certificate according to the option selected by the verifier D1. The online system B0 generates another unique URL (hereinafter, may be intermittently referred to as “second unique URL”) i.e. for the verification certificate. The online system B0 provides the verification certificate with the second unique URL written on the verification certificate to the verifier D1. The online system B0 also stores an original copy of the verification certificate in the database B2 hosted by the online system B0. At step 210, the verifier D1 presents the verification certificate to the cross verifier D2 as a proof of verification. At step 211, the cross verifier D2 visits the second unique URL printed on the verification certificate using any internet enabled device such as but not limited to laptop, PC, PDA, smart phone, tablet, or any other such device known to an ordinary skilled in the art. The second unique URL links the cross verifier D2 with the online system B0 and displays the original copy of the verification certificate stored at the database B2 hosted by the online system B0. The cross verifier D2 can compare the submitted copy of the document with the original copy and ascertain the genuineness of the verification document. In one embodiment, the data entry subsystem B1 and verification certificates B2 are separate modules which are interconnected with the online system B0. In another embodiment, the data entry subsystem B1 and verification certificates B2 are integrated and part of the online system B0.

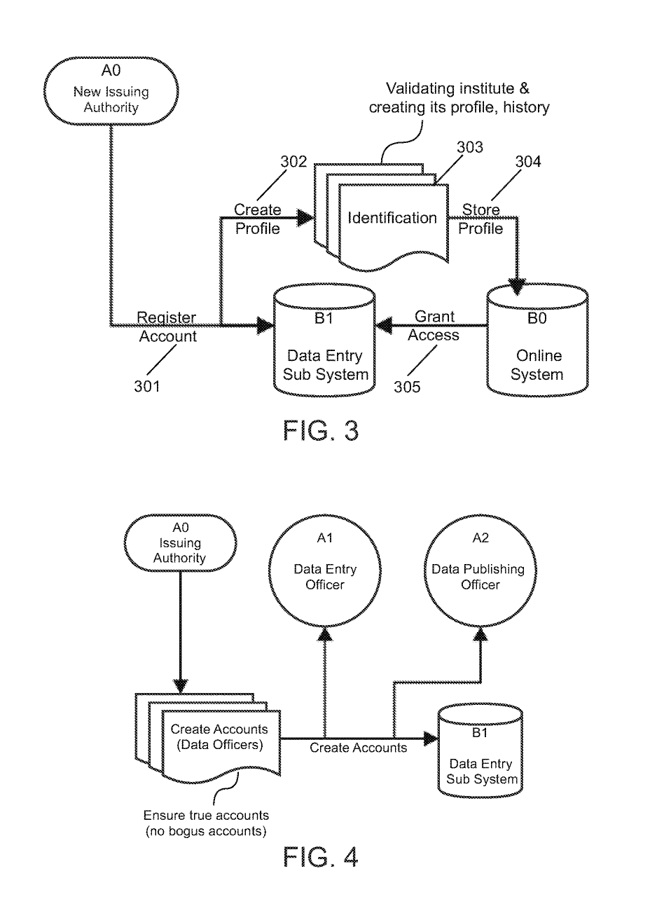

FIG. 3 shows a flow diagram illustrating the enrollment of a new issuing authority A0 with the online system B0 according to an exemplary embodiment of the present invention. The enrollment of a new issuing authority A0 with the online system B0 creates a trust level 1 in the system of the present invention.

As shown in FIG. 3, the new issuing authority A0 registers onto the online system B0 at step 301 and creates a profile by entering required details about the issuing authority A0 at step 302. At step 303, a data entry subsystem B1 validates the information entered by the issuing authority A0 by checking history and record of the issuing authority A0. Once validated, the profile of the issuing authority A0 is stored in a database hosted by the online system B0 at step 304 and access to the online system B0 is granted to the issuing authority A0 at step 305.

FIG. 4 shows a flow diagram illustrating the creation of accounts, of the data entry officer A1 and the data publishing officer A2 of the issuing authority A0 on the data entry subsystem B1 of the online system (not shown). The creation of accounts of two data officers creates a trust level 2 in the system of the present invention. The data entry officer A1 is responsible for entering data related to a document on the online system and the data publishing officer A2 validates the data entered by the data entry officer A1.

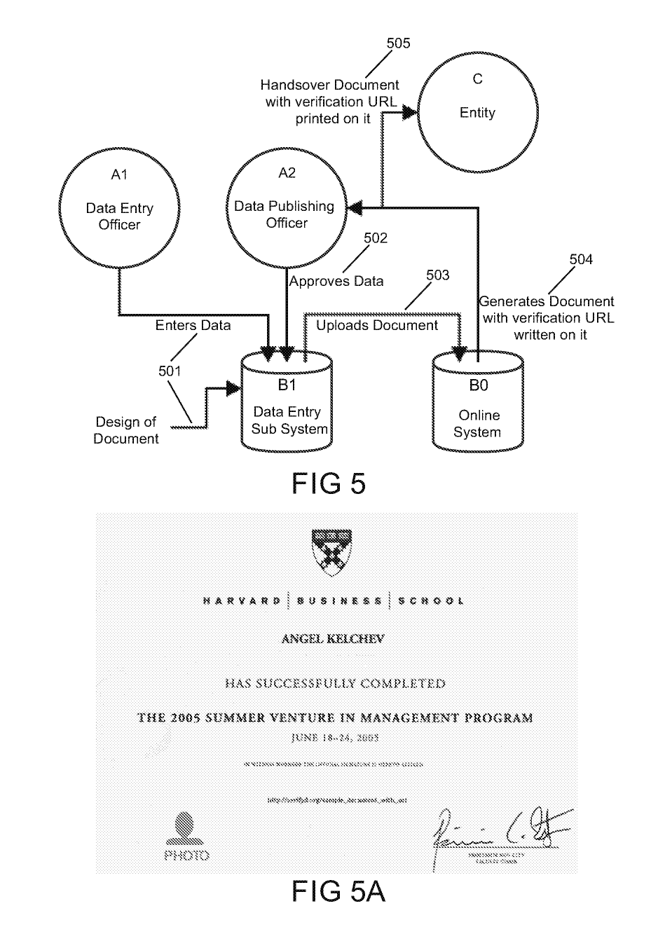

FIG. 5 shows a flow diagram illustrating the creation of a document to be issued by an issuing authority (not shown) according to an exemplary embodiment of the present invention. At step 501, the data entry officer A1 of the issuing authority uploads a design template for the document and information about the document and an entity C to whom the document is to be issued on the data entry subsystem B1 of the online system B0. The design template of the document may also be created at the online system B0 and can be approved by the issuing authority. At step 502, the data publishing officer A2 approves the information entered by the data entry officer A1 thus creating a trust level 3 in the system of the present invention. At step 503, the data entry subsystem B1 creates the document on the basis of the template and the information entered by the data entry officer A1 and uploads the created document on the online system B0 which, at step 504, generates a unique URL for the document and provides the document with the unique URL written on it to the data publishing officer A2. The online system B0 also stores an original copy of the document on a database (not shown) hosted by the online system B0. The functionalities of the online system B0 are implemented using one or more processing elements, which are not herein explained in detail as they are very well known to an ordinary skilled in the related art.

At step 505, the data publishing officer A2 issues a printed copy of the document to the entity C with the unique URL printed on the document.

FIG. 5-A illustrates a sample document with verification URL printed on it as generated by the online system B0 of FIG. 5 in accordance with an exemplary embodiment of the present invention. It should be noted that the document shown in FIG. 5-A is just for illustration purpose and other modifications in the design, content, and appearance are also possible.

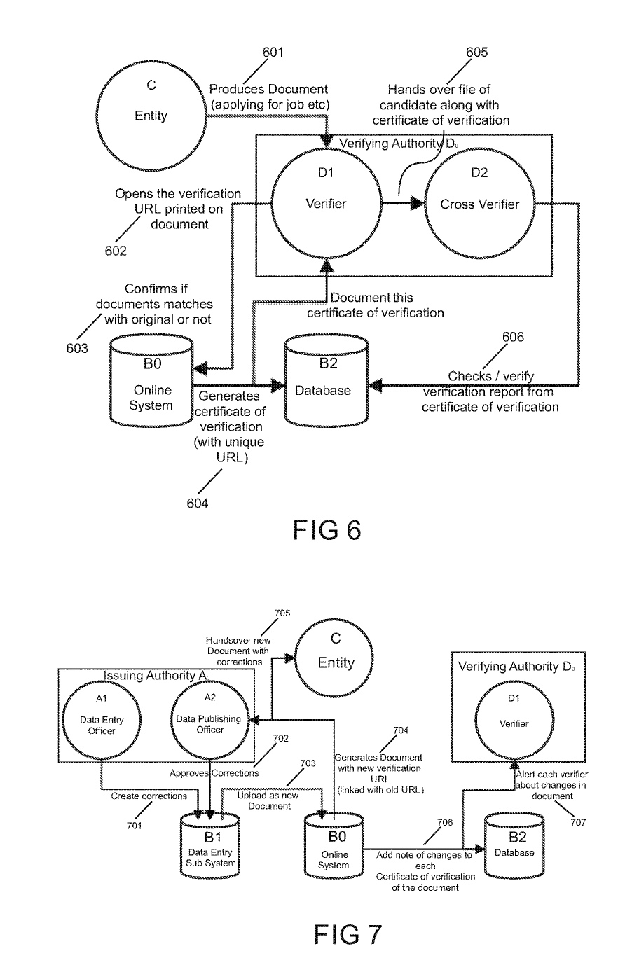

FIG. 6 shows a flow diagram illustrating the verification of a document presented by an entity C in an organization. At step 601, the entity C submits copy of the document to the organization. The organization has a verifying authority D which comprises of a verifier D1 and a cross verifier D2. The verifications performed by the verifier D1 and the cross verifier D2 creates trust levels 4 and 5 respectively in the system of the present invention.

At step 602, the verifier D1 visits a unique URL printed on the document using any internet enabled device such as but not limited to laptop, PC, PDA, smart phone, tablet, or any other such device known to an ordinary skilled in the art. At step 603, the unique URL links the verifier D1 with the online system B0 and displays the original copy of the document stored at the database B2 hosted by the online system B0. The verifier D1 can compare the submitted copy of the document with the original copy and if the submitted document matches the original copy, the verifier D1 ascertains the genuineness of the document by selecting an option “Match” on an interface provided by the online system B0. But if the submitted document does not match with the original copy, the verifier D1 selects another option “Does Not Match” on the interface provided by the online system B0.

Once the verifier D1 ascertains the genuineness of the document, then at step 604, the online system B0 generates a verification certificate according to the option selected by the verifier D1. The online system B0 also generates another (second) unique URL for the verification certificate. The online system B0 provides the verification certificate with the other unique URL written on the verification certificate to the verifier D1. The online system B0 also stores an original copy of the verification certificate in the database B2 hosted by the online system B0. At step 605, the verifier D1 shows the verification certificate to the cross verifier D2 as a proof of verification. At step 606, the cross verifier D2 visits the second unique URL printed on the verification certificate using any internet enabled device such as but not limited to laptop, PC, PDA, smart phone, tablet, or any other such device known to an ordinary skilled in the art. The second unique URL links the cross verifier D2 with the online system B0 and displays the original copy of the verification certificate stored at the database B2 hosted by the online system B0. The cross verifier D2 can compare the submitted copy of the verification certificate with the original copy and ascertain the genuineness of the verification certificate.

FIG. 7 shows a flow diagram illustrating the correction and updation of a document issued by the issuing authority A0 to the entity C according to an exemplary embodiment of the present invention. The corrections made in the document are saved in the online system B0 and the verifying authority D0 is notified about the corrections. The correction and updation of the issued document creates a trust level 6 in the system of the present invention.

The issuing authority A0 can make corrections in the document issued to entity C as and when required. At step 701, the data entry officer A1 enters the correction data on the data entry subsystem B1 of the online system B0 and at step 702, the data publishing officer B2 approves the correction data entered by the data entry officer A1. At step 703, the data entry subsystem B1 creates a new document (re-creation of the original document with corrected data) with the corrected data and uploads the new document on the online system B0. In an embodiment, the data entry subsystem B1 may update the old copy of the document with the corrected data. At step 704, online system B0 generates a new unique URL for the document and links the new URL of the document with old URL for the document and the online system B0 provides the new document with the new URL written on it to the data publishing officer A2. At step 705, the data publishing officer A2 issues a printed copy the new (re-created) document with the new URL printed on it to the entity C.

At step 706, the online system B0 stores the new document in the database B2 hosted by the online system B0. The online system B0 also checks whether the old document had been verified by any verifying authority D0. If the online system B0 finds that some verification certificate exists for the old document i.e. the old document had been verified by verifying authority D0, then the online system B0 makes a note in the verification certificates that the corresponding document has been updated. At step 707, the online system B0 notifies the corresponding verifying authority D0 about the corrections and updation of the document. This creates a trust level 6 in the system of the present invention.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

1-6. (canceled)

7. A method for creating a verification certificate for a document, the method comprising:
creating a verification certificate and appending a unique URL on the verification certificate, wherein the verification certificate is created when a verifying authority ascertains genuineness of a document;
storing a copy of the verification certificate in a database, wherein the stored verification certificate is accessible by visiting the unique URL; and
providing the verification certificate with the appended unique URL to the verifying authority.

8. The method of claim 7, wherein the copy of the verification certificate stored in the database is accessible to an end user in real-time over a network.

9. The method of claim 7, wherein an end user visits the unique URL for accessing the copy of the verification certificate stored in the database.

10. The method of claim 7, wherein the copy of the verification certificate stored in the database is used to determine authenticity of the document that is under verification.

11-14. (canceled)

15. A system for facilitating creation of a verifiable document, the system comprising:
a database;
at least one processor configured to perform operations comprising:
receiving data associated with a document from a document issuing authority;
creating the document according to the received data and appending a first unique URL on the document, wherein the document is verified by visiting the first unique URL appended on the document;
storing a copy of the document in the database, wherein the stored document is accessible by visiting the first unique URL; and
providing the document with the appended first unique URL to the document issuing authority.

16. The system of claim 15, wherein the at least one processor is further configured to provide the copy of the document stored in the database to an end user in real-time over a network, when the end user visits the unique URL.

17-22. (canceled)

23. A system for facilitating verification of genuineness of a document, the system comprising:
a database;
at least one processor configured to perform operations comprising:
receiving data associated with the document from a document issuing authority;
creating the document according to the received data and appending a first unique URL on the document;
storing a copy of the document in the database, wherein the stored document is accessible by visiting the first unique URL;
providing the document with the appended first unique URL to the document issuing authority;
receiving a verification request associated with the document from a verifying authority;
providing the stored copy of the document to the verifying authority over a network, wherein the verifying authority analyses the stored copy and ascertain the genuineness of the document by selecting an option on a user interface on a device operated by the verifying authority;
creating a verification certificate according to the option selected by the verifying authority and appending a second unique URL on the verification certificate;
storing a copy of the verification certificate in the database, wherein the stored verification certificate is accessible by visiting the second unique URL; and
providing the verification certificate with the appended second unique URL to the verifying authority over the network.

24. The system of claim 23, wherein the at least one processor is further configured to provide the copies of the document and the verification certificate stored in the database to an end user in real-time over the network, when the end user visits the respective unique URL associated with the document and the verification certificate.

25. (canceled)

26. The system of claim 15, wherein the at least one processor is further configured to perform operations comprising:
receiving corrections in the data associated with the document from the document issuing authority;
re-creating the document according to the received corrections and appending a second unique URL on the document;
storing a copy of the re-created document in the database, wherein the stored copy of the re-created document is accessible by visiting the second unique URL;
linking the second unique URL with the first unique URL;
providing the re-created document with the second unique URL to the document issuing authority; and
notifying a verifying authority corresponding to the corrections made in the data associated with the document.

27. The system of claim 15, wherein the at least one processor is further configured to perform operations comprising:
receiving a verification request associated with the document from a verifying authority; and
sending the stored copy of the document to the verifying authority to verify the authenticity of the document.

28. The system of claim 23, wherein the at least one processor is further configured to perform operations comprising:
receiving corrections in the data associated with the document from the document issuing authority;
re-creating the document according to the received corrections and appending a third unique URL on the document;
storing a copy of the re-created document in the database, wherein the stored copy of the re-created document is accessible by visiting the third unique URL;
linking the third unique URL with the first unique URL;
providing the re-created document with the third unique URL to the document issuing authority; and
notifying the verifying authority corresponding to the corrections made in the data associated with the document.
